(19) United States
(12) Patent Application Publication
(10) Pub. No.: US 2011/0059200 A1
(43) Pub. Date: Mar. 10, 2011

(54) Double Mold Locking Apparatus

(76) Inventors: Jung-Teng Lin, Yongkang City (TW); Chung-Hsien Lin, Yongkang City (TW); Tzu-Tse Wu, Yongkang City (TW)

(21) Appl. No.: 12/556,824

(22) Filed: Sep. 10, 2009

(51) Int. Cl. B29C 33/24

(52) U.S. Cl. 425/541

(57) ABSTRACT

A double mold locking apparatus includes a mold unit and a plurality of positioning devices. The mold unit includes a fixed mold, a movable mold, a plurality of support rods and a plurality of driving cylinders. Each of the positioning devices includes a high pressure locking cylinder, two opposite semi-nuts and a position finder. Thus, the position of each of the support rods relative to the semi-nuts of the respective positioning device is micro-adjusted when the first die and the second die are opened and closed, so that a user only needs to calibrate the position of each of the support rods at the first time when the first die and the second die are opened and closed without having to adjust and calibrate the position of each of the support rods at each cycle.

### BACKGROUND OF THE INVENTION

1. Field of the Invention

The present invention relates to a locking apparatus and, more particularly, to a double mold locking apparatus.

2. Description of the Related Art

A conventional double mold locking apparatus in accordance with the prior art shown in FIGS. 13-17 comprises a fixed mold 50, a first die 52 mounted on the fixed mold 50, a movable mold 51 movable relative to the fixed mold 50, a second die 53 mounted on the movable mold 51 and movable relative to the first die 52, a plurality of support rods 54 extending through and movable relative to the fixed mold 50 and the movable mold 51, a plurality of hydraulic cylinders 55 mounted on the fixed mold 50 and connected with the support rods 54 to drive the support rods 54 to move relative to the fixed mold 50 and the movable mold 51, a drive member 56 connected with the hydraulic cylinders 55 to drive the hydraulic cylinders 55, and a plurality of locking members 57 movably mounted on the movable mold 51 and movable relative to the support rods 54. Each of the support rods 54 is provided with a locking groove 58. In operation, when the movable mold 51 is moved toward the fixed mold 50, the second die 53 is moved to press the first die 52 as shown in FIG. 13 so that the first die 52 and the second die 53 are closed. Then, the hydraulic cylinders 55 are driven by the drive member 56 to move the support rods 54 backward until the locking groove 58 of each of the support rods 54 is aligned with each of the locking members 57 as shown in FIG. 14. Then, each of the locking members 57 is moved toward each of the support rods 54 and is inserted into the locking groove 58 of each of the support rods 54. Then, the support rods 54 are driven by the hydraulic cylinders 55 to move forward and to press the locking members 57 toward the movable mold 51 as shown in FIG. 15 so that the locking members 57 transmits a high pressure to the movable mold 51 so as to press the movable mold 51 toward the fixed mold 50 and to lock the first die 52 and the second die 53. After the molding process is accomplished, the support rods 54 are driven by the hydraulic cylinders 55 to move backward and to release the locking members 57 as shown in FIG. 16 so that the high pressure applied by the locking members 57 is released. Finally, the support rods 54 are driven by the hydraulic cylinders 55 to move backward successively and to move the locking members 57 backward as shown in FIG. 17 so that the second die 53 is moved to space from the first die 52 so that the first die 52 and the second die 53 are opened. However, the double mold locking apparatus comprises many hydraulic cylinders 55 that will elongate the calibration time of the first die 52 and the second die 53 so that the working efficiency of the molding process is decreased.

### BRIEF SUMMARY OF THE INVENTION

In accordance with the present invention, there is provided a double mold locking apparatus, comprising a mold unit and a plurality of positioning devices. The mold unit includes a fixed mold for mounting a first die, a movable mold movable relative to the fixed mold to drive a second die to move relative to the first die, a plurality of support rods extending through the fixed mold and the movable mold, and a plurality of driving cylinders mounted between the fixed mold and the movable mold to drive the movable mold to move relative to the fixed mold reciprocally. Each of the positioning devices includes a high pressure locking cylinder to transmit a locking force to the movable mold of the mold unit so as to apply a high pressure to the first die and the second die when the first die and the second die are closed, two opposite semi-nuts movable relative to each other to clamp a respective one of the support rods of the mold unit between the two semi-nuts, and a position finder to find a position of the respective support rod of the mold unit.

The primary objective of the present invention is to provide a double mold locking apparatus that only needs to calibrate the distance of two dies once during the molding process.

According to the primary objective of the present invention, the position of the outer threaded portion of each of the support rods relative to the semi-nuts of the respective positioning device is micro-adjusted when the first die and the second die are opened and when the first die and the second die are closed, so that a user only needs to calibrate the position of each of the support rods at the first time when the first die and the second die are opened and closed without having to adjust and calibrate the position of each of the support rods at each cycle when the first die and the second die are opened and closed reciprocally so as to save the working time during the molding process and to facilitate the molding operation.

According to another objective of the present invention, the high pressure locking cylinder of each of the positioning devices is positioned in place by operation of the positioning cylinder so as to lock the first die and the second die exactly and closely.

According to a further objective of the present invention, the support rods are locked onto the fixed mold by the driven gears of the regulating unit so as to provide a support to the fixed mold.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front cross-sectional view of a double mold locking apparatus in accordance with the preferred embodiment of the present invention.

FIG. 2 is a side view of the double mold locking apparatus as shown in FIG. 1.

FIG. 3 is a schematic operational view of the double mold locking apparatus as shown in FIG. 2.

FIG. 4 is a schematic operational view of the double mold locking apparatus as shown in FIG. 1.

FIG. 5 is a schematic operational view of the double mold locking apparatus as shown in FIG. 4.

FIG. 6 is a locally enlarged view of the double mold locking apparatus taken along circle “A” as shown in FIG. 5.

FIG. 7 is a schematic operational view of the double mold locking apparatus as shown in FIG. 5.

FIG. 8 is a locally enlarged view of the double mold locking apparatus taken along circle “B” as shown in FIG. 7.

FIG. 9 is a schematic operational view of the double mold locking apparatus as shown in FIG. 7.

FIG. 10 is a locally enlarged view of the double mold locking apparatus taken along circle “C” as shown in FIG. 9.

FIG. 11 is a schematic operational view of the double mold locking apparatus as shown in FIG. 9.

FIG. 12 is a schematic operational view of the double mold locking apparatus as shown in FIG. 11.

FIG. 13 is a front cross-sectional view of a conventional double mold locking apparatus in accordance with the prior art.

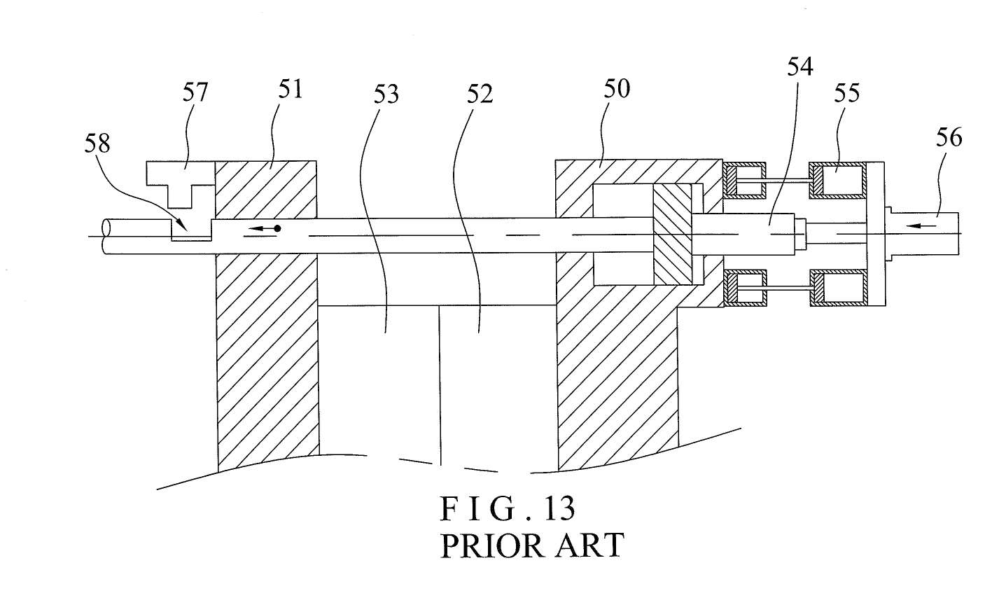

FIG. 14 is a schematic operational view of the conventional double mold locking apparatus as shown in FIG. 13.

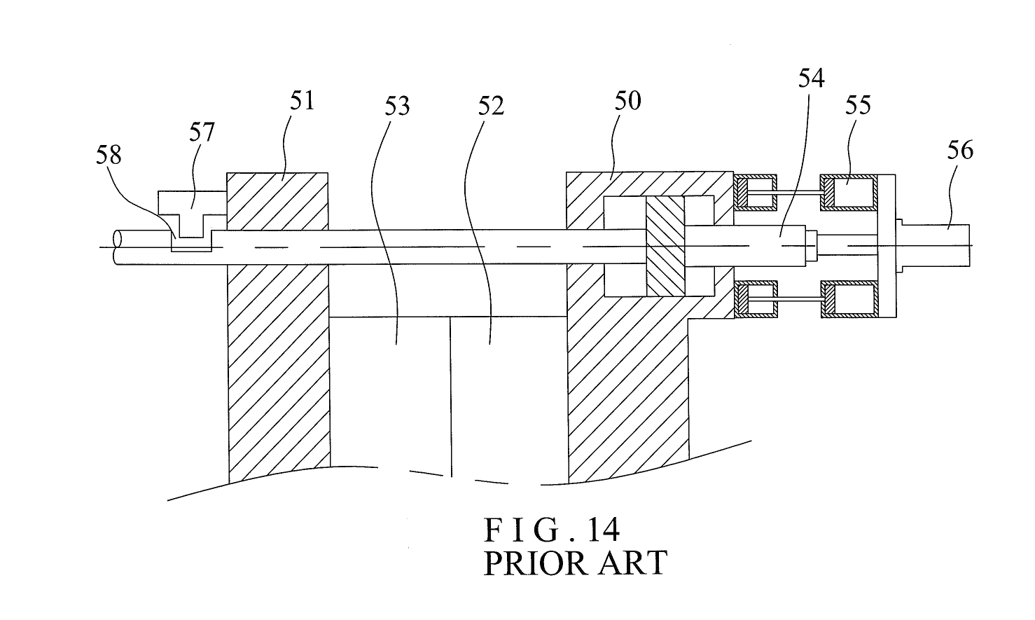

FIG. 15 is a schematic operational view of the conventional double mold locking apparatus as shown in FIG. 14.

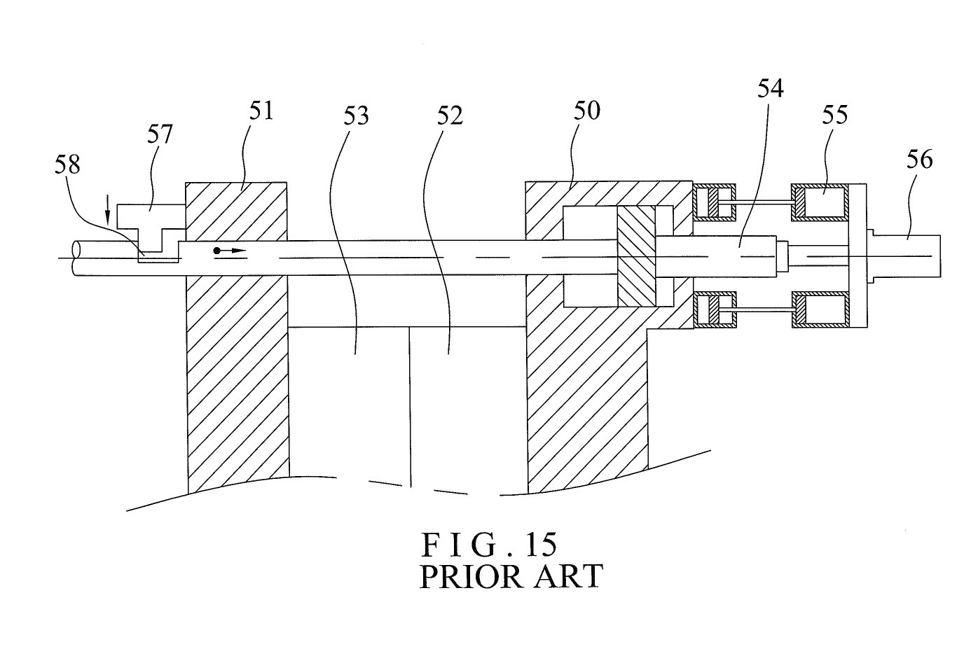

FIG. 16 is a schematic operational view of the conventional double mold locking apparatus as shown in FIG. 15.

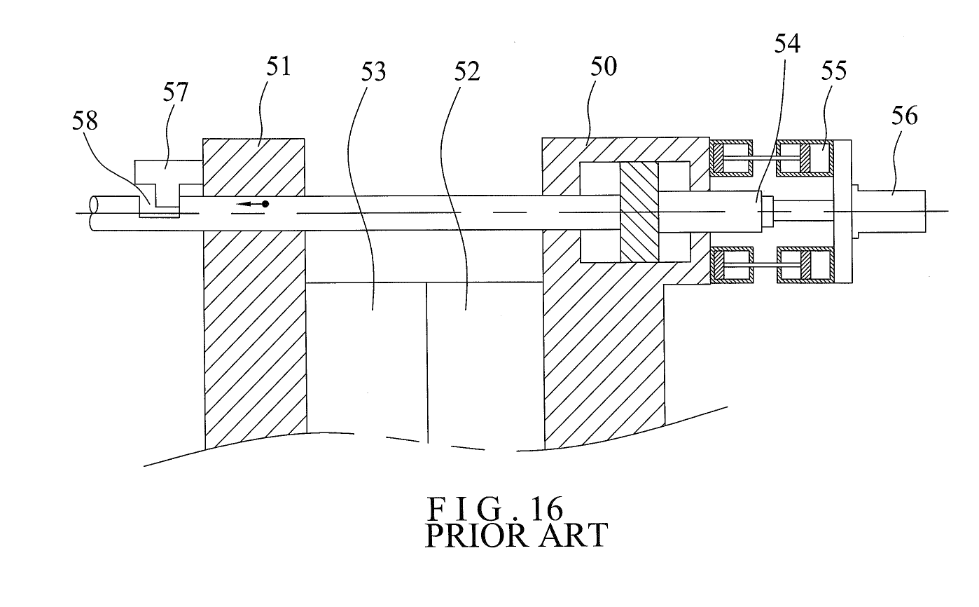

FIG. 17 is a schematic operational view of the conventional double mold locking apparatus as shown in FIG. 16.

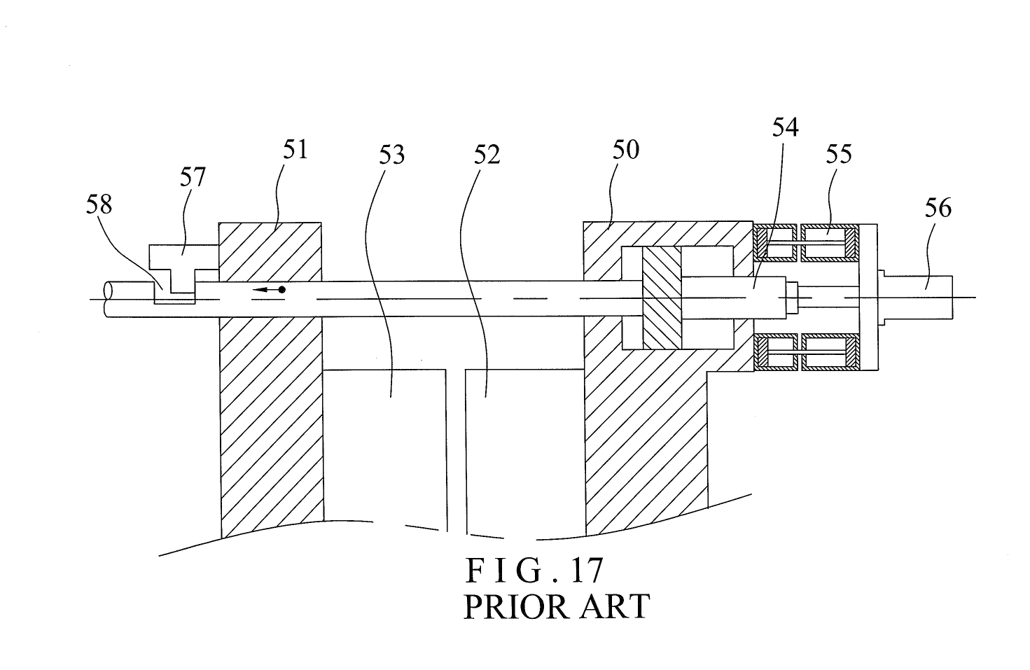

### DETAILED DESCRIPTION OF THE INVENTION

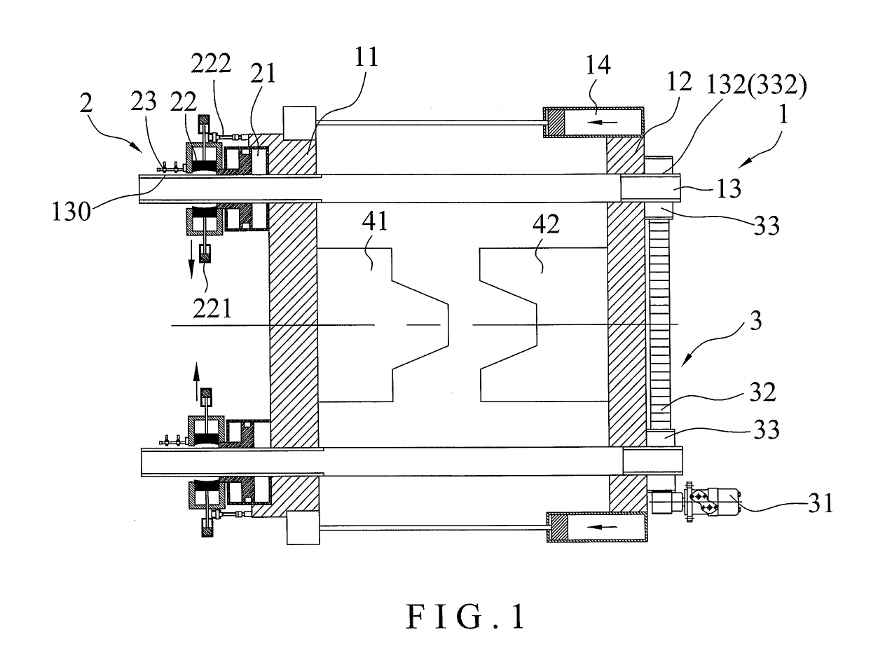

Referring to the drawings and initially to FIGS. 1-3, a double mold locking apparatus in accordance with the preferred embodiment of the present invention comprises a mold unit 1, a plurality of positioning devices 2 and a regulating unit 3.

The mold unit 1 includes a fixed mold 12 for mounting a first die 42, a movable mold 11 movable relative to the fixed mold 12 to drive a second die 41 to move relative to the first die 42, a plurality of (preferably four) support rods 13 extending through the fixed mold 12 and the movable mold 11, and a plurality of (preferably four) driving cylinders 14 mounted between the fixed mold 12 and the movable mold 11 to drive the movable mold 11 to move relative to the fixed mold 12 reciprocally.

The movable mold 11 of the mold unit 1 is movable on the support rods 13. The support rods 13 of the mold unit 1 extend through four corners of each of the fixed mold 12 and the movable mold 11 and are movable in the fixed mold 12 and the movable mold 11. The support rods 13 of the mold unit 1 are positioned in place temporarily by a positioning mold (not shown) which is spaced from the movable mold 11. Each of the support rods 13 of the mold unit 1 is provided with an outer threaded portion 130 and an outer threaded section 132.

Each of the positioning devices 2 is mounted on a first side of the mold unit 1 and includes a high pressure locking cylinder 21 to transmit a locking force to the movable mold 11 of the mold unit 1 so as to apply a high pressure to the first die 42 and the second die 41 when the first die 42 and the second die 41 are closed, two opposite semi-nuts 22 movable relative to each other to clamp a respective one of the support rods 13 of the mold unit 1 between the two semi-nuts 22, and a position finder 23 to find a position of the respective support rod 13 of the mold unit 1.

The high pressure locking cylinder 21 of each of the positioning devices 2 is mounted on the movable mold 11 of the mold unit 1. The two semi-nuts 22 of each of the positioning devices 2 are mounted beside the high pressure locking cylinder 21. The two semi-nuts 22 of each of the positioning devices 2 are movable toward the respective support rod 13 of the mold unit 1 to mesh with the outer threaded portion 130 of the respective support rod 13 so as to lock the respective support rod 13. The position finder 23 of each of the positioning devices 2 is mounted beside the semi-nuts 22. The position finder 23 of each of the positioning devices 2 has a detector (not shown) to detect the threading position of the outer threaded portion 130 of the respective support rod 13 when the first die 42 and the second die 41 are opened or closed to align the semi-nuts 22 of each of the positioning devices 2 with the outer threaded portion 130 of the respective support rod 13.

Each of the positioning devices 2 further includes two opposite actuating cylinders 221 mounted beside the high pressure locking cylinder 21 and connected with the two semi-nuts 22 to move the two semi-nuts 22 relative to the respective support rod 13 of the mold unit 1 and a positioning cylinder 222 mounted between the two semi-nuts 22 and the movable mold 11 of the mold unit 1 and connected with the high pressure locking cylinder 21 to regulate and locate the position of the high pressure locking cylinder 21.

The regulating unit 3 is mounted on a second side of the mold unit 1 and includes a plurality of (preferably four) driven gears 33 each provided with an inner threaded section 332 screwed onto the outer threaded section 132 of the respective support rod 13 to releasably lock the respective support rod 13 onto the fixed mold 12 of the mold unit 1, a drive gear 32 intermeshing with the driven gears 33 to drive each of the driven gears 33 to rotate relative to the respective support rod 13 of the mold unit 1 respectively, and a drive motor 31 connected with the drive gear 32 to rotate the drive gear 32.

The drive gear 32 of the regulating unit 3 is located between the driven gears 33 and abuts the fixed mold 12 of the mold unit 1. The drive gear 32 of the regulating unit 3 has a diameter greater than that of each of the driven gears 33. Each of the driven gears 33 of the regulating unit 3 surrounds the respective support rod 13 of the mold unit 1 and is movable to abut the fixed mold 12 of the mold unit 1.

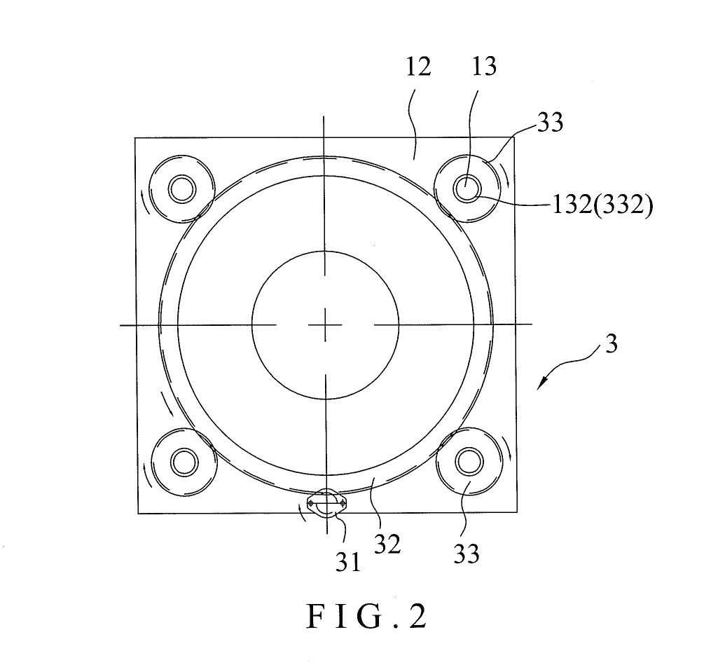

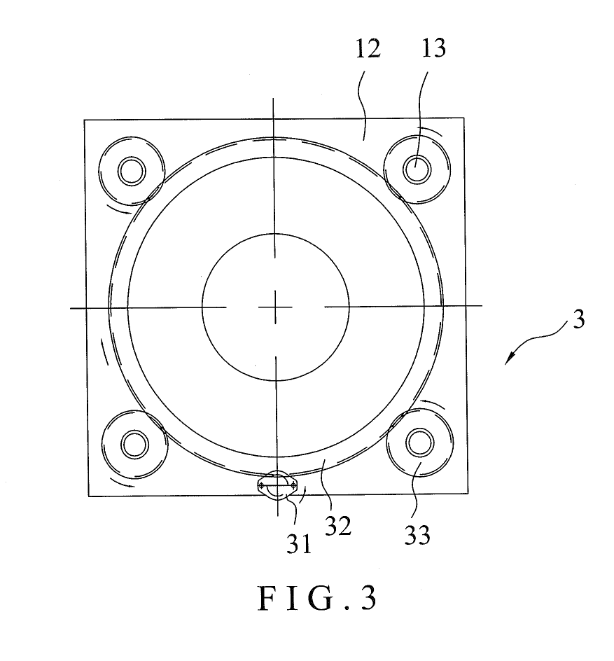

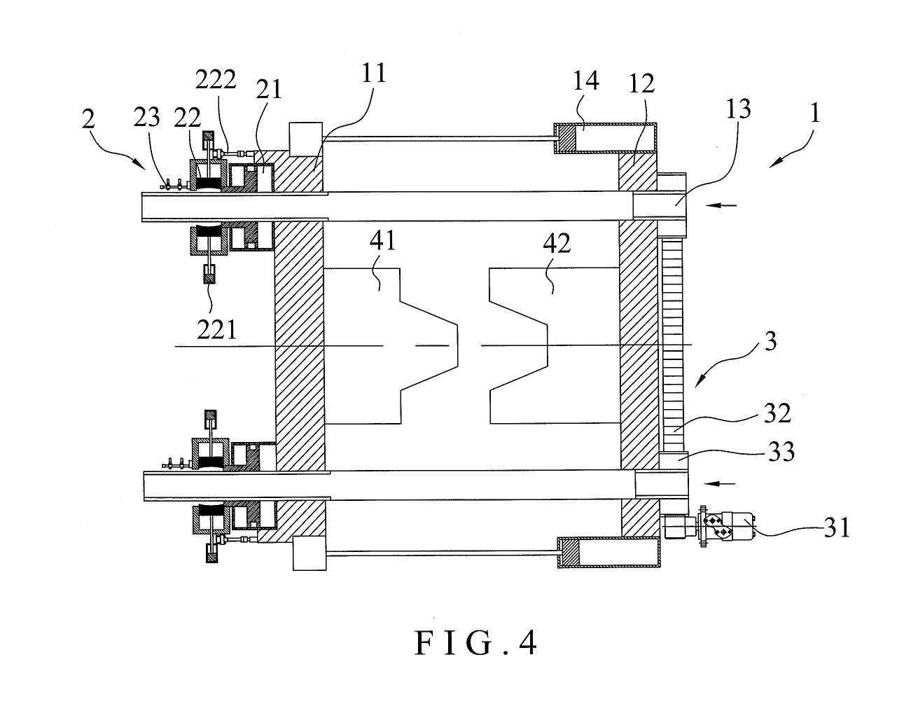

In practice, the support rods 13 of the mold unit 1 are positioned in place temporarily by the positioning mold. In such a manner, when the drive motor 31 is operated in the positive direction, the drive gear 32 is rotated counterclockwise as shown in FIG. 2 to rotate the driven gears 33 clockwise so that the inner threaded section 332 of the driven gears 33 is screwed onto the outer threaded section 132 of the respective support rod 13 to lock the respective support rod 13 onto the fixed mold 12 of the mold unit 1. On the contrary, when the drive motor 31 is operated in the negative direction, the drive gear 32 is rotated clockwise as shown in FIG. 3 to rotate the driven gears 33 counterclockwise so that the inner threaded section 332 of the driven gears 33 is unscrewed from the outer threaded section 132 of the respective support rod 13 to unlock the respective support rod 13 from the fixed mold 12 of the mold unit 1. Then, the support rods 13 of the mold unit 1 are loosened from the positioning mold so that each of the support rods 13 of the mold unit 1 is movable freely relative to the fixed mold 12 as shown in FIG. 4 to micro-adjust the position of each of the support rods 13 relative to the two semi-nuts 22 of the respective positioning device 2. After adjustment of the position of each of the support rods 13 is accomplished, the support rods 13 of the mold unit 1 are positioned in place by the positioning mold. Then, the drive gear 32 is rotated counterclockwise as shown in FIG. 2 to rotate the driven gears 33 clockwise so that the inner threaded section 332 of the driven gears 33 is screwed onto the outer threaded section 132 of the respective support rod 13 to lock the respective support rod 13 onto the fixed mold 12 of the mold unit 1.

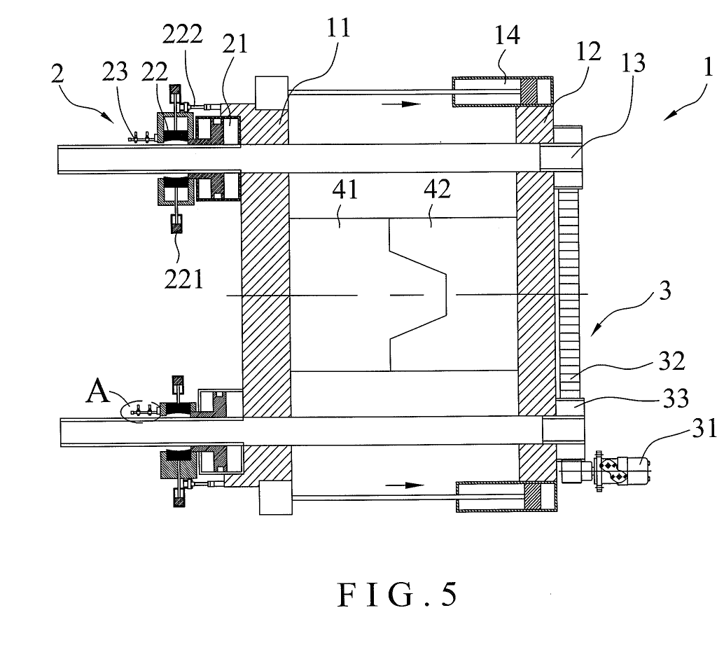

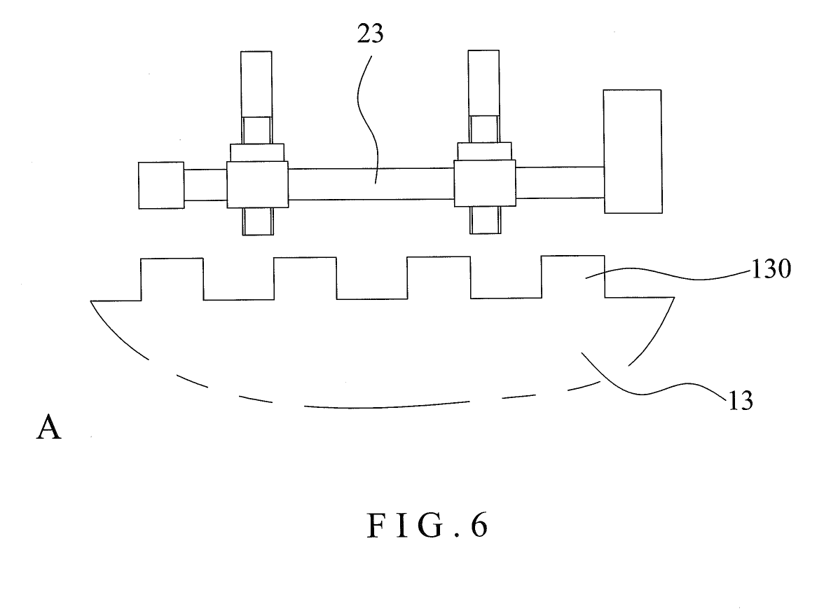

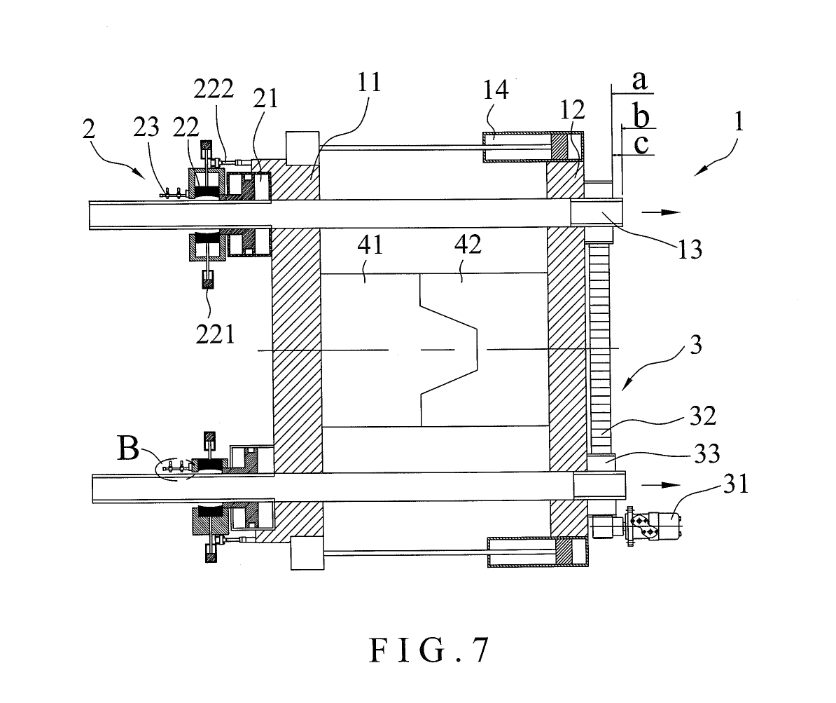

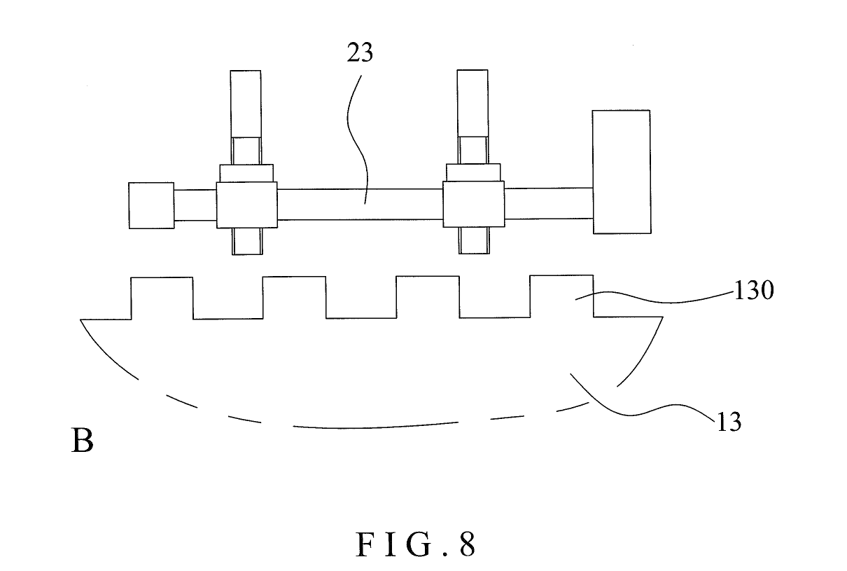

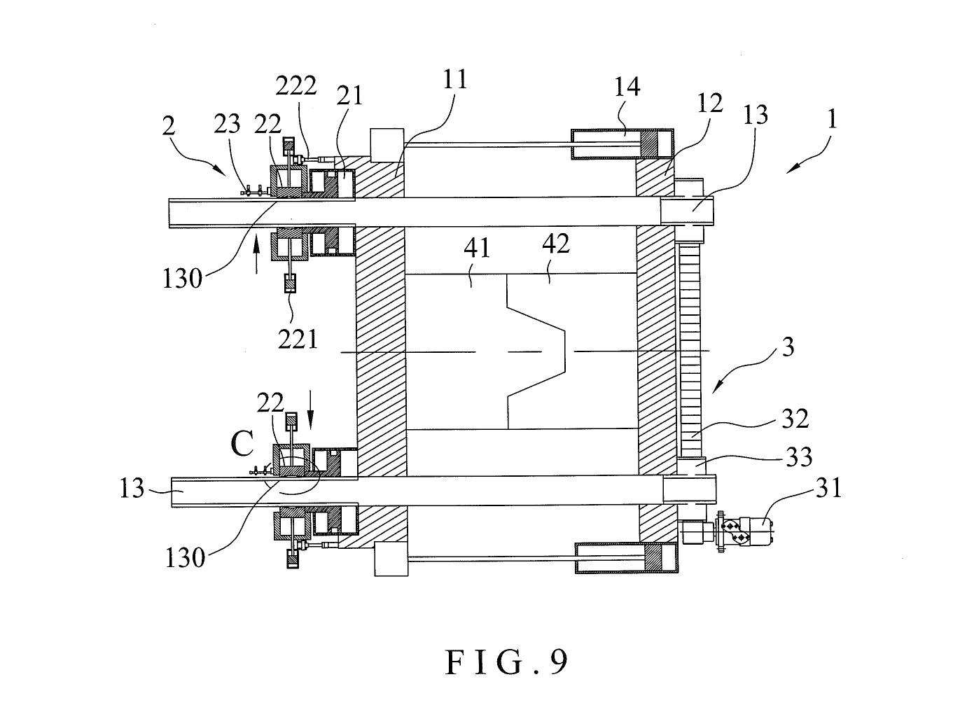

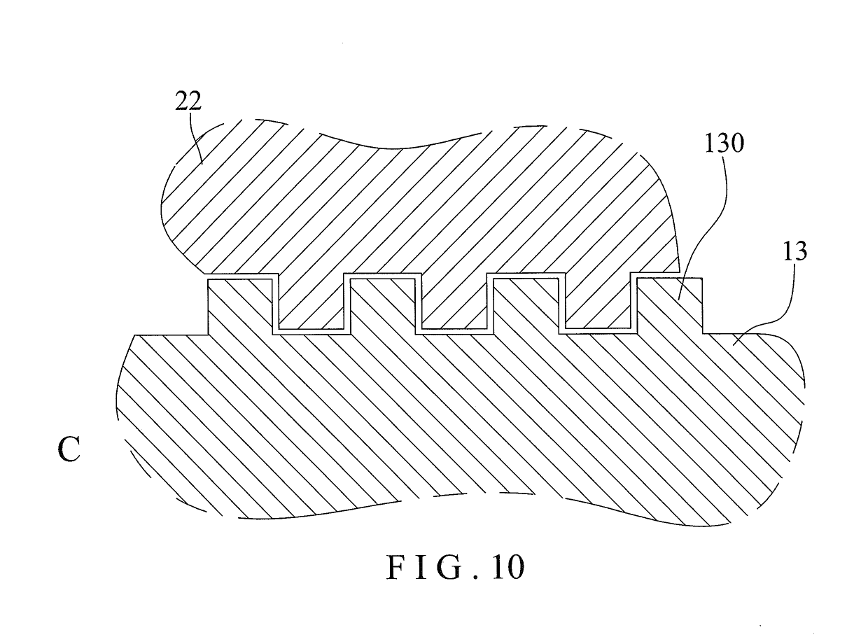

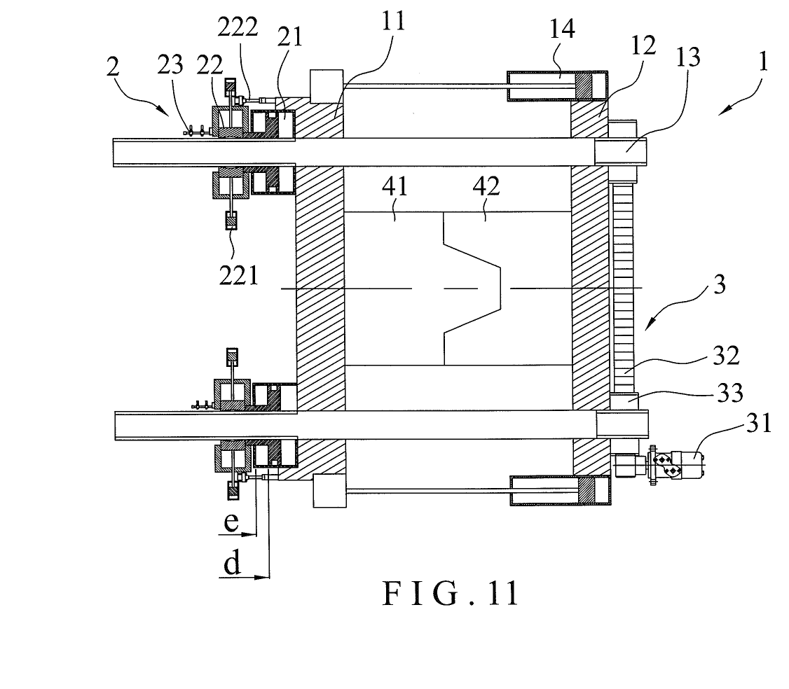

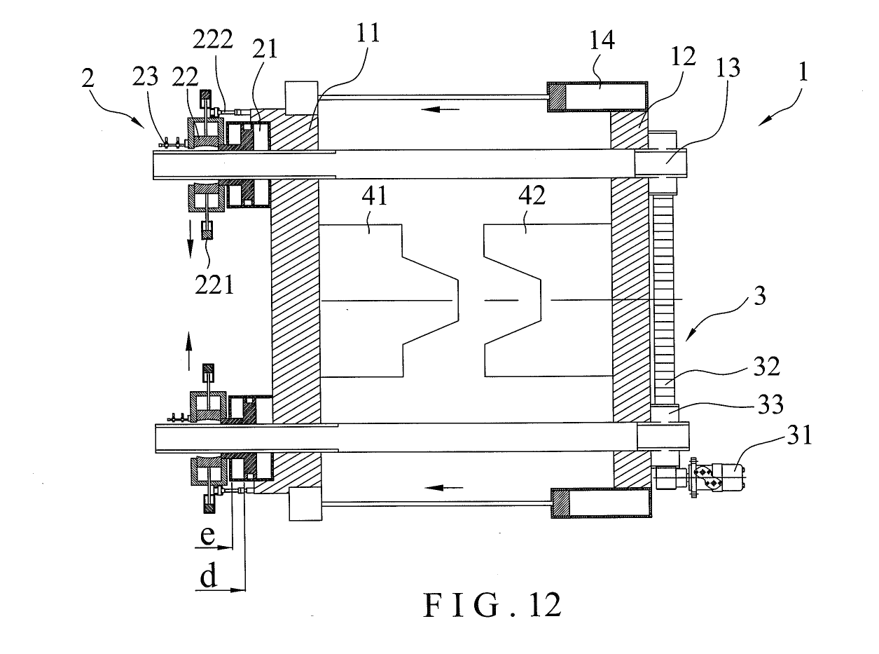

In operation, referring to Figs. FIGS. 1-12, the driving cylinders 14 are operated to drive the movable mold 11 to space from the fixed mold 12 as shown in FIG. 1. Then, the first die 42 is mounted on the fixed mold 12, and the second die 41 is mounted on the movable mold 11. At this time, the regulating unit 3 is operated to unlock the support rods 13 so that each of the support rods 13 of the mold unit 1 is movable freely relative to the fixed mold 12 as shown in FIG. 4 to micro-adjust the position of each of the support rods 13 relative to the two semi-nuts 22 of the respective positioning device 2. Then, the driving cylinders 14 are operated to drive the movable mold 11 to move toward the fixed mold 12 as shown in FIG. 5 until the second die 41 abuts the first die 42 so as to close the first die 42 and the second die 41. At the same time, the position finder 23 of each of the positioning devices 2 detects the position of the outer threaded portion 130 of the respective support rod 13 as shown in FIG. 6 when the first die 42 and the second die 41 are closed. Then, the regulating unit 3 is operated to unlock the support rods 13 so that each of the support rods 13 of the mold unit 1 is movable freely relative to the fixed mold 12 as shown in FIG. 7 to micro-adjust the position of each of the support rods 13 relative to the two semi-nuts 22 of the respective positioning device 2, and the position finder 23 of each of the positioning devices 2 detects the position of the outer threaded portion 130 of the respective support rod 13 as shown in FIG. 8. At this time, each of the support rods 13 has a determined micro-adjustment range “c” that is limited between the minimum position “a” and the maximum position “b” as shown in FIG. 7. After the position finder 23 of each of the positioning devices 2 confirms the exact position of the outer threaded portion 130 of the respective support rod 13 as shown in FIG. 8, adjustment of the position of each of the support rods 13 is accomplished as shown in FIG. 7. Subsequently, the actuating cylinders 221 of each of the positioning devices 2 are operated to move the two semi-nuts 22 toward the respective support rod 13 of the mold unit 1 so as to clamp and position the respective support rod 13 of the mold unit 1 as shown in FIG. 9. At this time, the two semi-nuts 22 of each of the positioning devices 2 mesh with the outer threaded portion 130 of the respective support rod 13 as shown in FIG. 10 so as to lock the respective support rod 13. Then, the high pressure locking cylinder 21 of each of the positioning devices 2 transmits a locking force to the movable mold 11 of the mold unit 1 to apply a high pressure to the first die 42 and the second die 41 so as to compress and lock the first die 42 and the second die 41 closely. At this time, the high pressure locking cylinder 21 of each of the positioning devices 2 is located at an expanded position “e” when the locking force is applied by the high pressure locking cylinder 21 of each of the positioning devices 2. After the molding process is accomplished, the locking force applied by the high pressure locking cylinder 21 of each of the positioning devices 2 is released so as to release the high pressure applied on the first die 42 and the second die 41. At this time, the high pressure locking cylinder 21 of each of the positioning devices 2 is located at a retracted position “d” when the locking force applied by the high pressure locking cylinder 21 of each of the positioning devices 2 is released. In such a manner, the high pressure locking cylinder 21 of each of the positioning devices 2 is movable between the expanded position “e” and the retracted position “d” as shown in FIG. 11 by operation of the positioning cylinder 222. Finally, the driving cylinders 14 of the mold unit 1 are operated to drive the movable mold 11 to move outwardly relative to the fixed mold 12 as shown in FIG. 12 until the second die 41 is spaced from the first die 42 so as to open the first die 42 and the second die 41.

Accordingly, the position of the outer threaded portion 130 of each of the support rods 13 relative to the semi-nuts 22 of the respective positioning device 2 is micro-adjusted when the first die 42 and the second die 41 are opened as shown in FIGS. 1 and 4 and when the first die 42 and the second die 41 are closed as shown in FIGS. 5 and 7, so that a user only needs to calibrate the position of each of the support rods 13 at the first time when the first die 42 and the second die 41 are opened and closed without having to adjust and calibrate the position of each of the support rods 13 at each cycle when the first die 42 and the second die 41 are opened and closed reciprocally so as to save the working time during the molding process and to facilitate the molding operation. In addition, the high pressure locking cylinder 21 of each of the positioning devices 2 is positioned in place by operation of the positioning cylinder 222 so as to lock the first die 42 and the second die 41 exactly and closely. Further, the support rods 13 are locked onto the fixed mold 12 by the driven gears 33 of the regulating unit 3 so as to provide a support to the fixed mold 12.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A double mold locking apparatus, comprising a mold unit and a plurality of positioning devices; wherein
the mold unit includes:
a fixed mold for mounting a first die;
a movable mold movable relative to the fixed mold to drive a second die to move relative to the first die;
a plurality of support rods extending through the fixed mold and the movable mold;
a plurality of driving cylinders mounted between the fixed mold and the movable mold to drive the movable mold to move relative to the fixed mold reciprocally;
each of the positioning devices includes:
a high pressure locking cylinder to transmit a locking force to the movable mold of the mold unit so as to apply a high pressure to the first die and the second die when the first die and the second die are closed;
two opposite semi-nuts movable relative to each other to clamp a respective one of the support rods of the mold unit between the two semi-nuts;
a position finder to find a position of the respective support rod of the mold unit.

2. The double mold locking apparatus of claim 1, wherein
each of the support rods of the mold unit is provided with an outer threaded section;
the double mold locking apparatus further comprises a regulating unit including:
a plurality of driven gears each provided with an inner threaded section screwed onto the outer threaded section of the respective support rod to releasably lock the respective support rod onto the fixed mold of the mold unit;
a drive gear intermeshing with the driven gears to drive each of the driven gears to rotate relative to the respective support rod of the mold unit respectively;
a drive motor connected with the drive gear to rotate the drive gear.

3. The double mold locking apparatus of claim 1, wherein
each of the support rods of the mold unit is provided with an outer threaded portion;
the position finder of each of the positioning devices detects a threading position of the outer threaded portion of the respective support rod when the first die and the second die are opened or closed to align the semi-nuts of each of the positioning devices with the outer threaded portion of the respective support rod.

4. The double mold locking apparatus of claim 1, wherein each of the positioning devices further includes:
two opposite actuating cylinders mounted beside the high pressure locking cylinder and connected with the two semi-nuts to move the two semi-nuts relative to the respective support rod of the mold unit.

5. The double mold locking apparatus of claim 1, wherein each of the positioning devices further includes:
a positioning cylinder mounted between the two semi-nuts and the movable mold of the mold unit and connected with the high pressure locking cylinder to regulate and locate a position of the high pressure locking cylinder.

6. The double mold locking apparatus of claim 1, wherein the movable mold of the mold unit is movable on the support rods.

7. The double mold locking apparatus of claim 1, wherein the support rods of the mold unit extend through four corners of each of the fixed mold and the movable mold.

8. The double mold locking apparatus of claim 1, wherein the support rods of the mold unit are movable in the fixed mold and the movable mold.

9. The double mold locking apparatus of claim 2, wherein
each of the positioning devices is mounted on a first side of the mold unit;
the regulating unit is mounted on a second side of the mold unit.

10. The double mold locking apparatus of claim 1, wherein the high pressure locking cylinder of each of the positioning devices is mounted on the movable mold of the mold unit.

11. The double mold locking apparatus of claim 1, wherein the two semi-nuts of each of the positioning devices are mounted beside the high pressure locking cylinder.

12. The double mold locking apparatus of claim 3, wherein the two semi-nuts of each of the positioning devices are movable toward the respective support rod of the mold unit to mesh with the outer threaded portion of the respective support rod so as to lock the respective support rod.

13. The double mold locking apparatus of claim 1, wherein the position finder of each of the positioning devices is mounted beside the semi-nuts.

14. The double mold locking apparatus of claim 2, wherein the drive gear of the regulating unit is located between the driven gears.

15. The double mold locking apparatus of claim 2, wherein the drive gear of the regulating unit abuts the fixed mold of the mold unit.

16. The double mold locking apparatus of claim 2, wherein the drive gear of the regulating unit has a diameter greater than that of each of the driven gears.

17. The double mold locking apparatus of claim 2, wherein each of the driven gears of the regulating unit surrounds the respective support rod of the mold unit.

18. The double mold locking apparatus of claim 2, wherein each of the driven gears of the regulating unit is movable to abut the fixed mold of the mold unit.
